(19) United States
(12) Patent Application Publication
(10) Pub. No.: US 2016/0154720 A1
(43) Pub. Date: Jun. 2, 2016

(54) PRESSURE TESTING METHOD AND PRESSURE TESTING DEVICE FOR A QUICK PATH INTERCONNECT BUS

(71) Applicants: Inventec (Pudong) Technology Corporation, Shanghai (CN); Inventec Corporation, Taipei (TW)

(72) Inventor: Yan LI, Shanghai (CN)

(21) Appl. No.: 14/952,358

(22) Filed: Nov. 25, 2015

(30) Foreign Application Priority Data
Nov. 28, 2014 (CN) 201410714223.4

(51) Int. Cl. G06F 11/30

(52) U.S. Cl. CPC G06F 11/3027; G06F 11/3024

(57) ABSTRACT

The present disclosure relates to a pressure testing method and a pressure testing device for a quick path interconnect bus. The pressure testing method comprises the following steps: A running a plurality of testing threads on a plurality of processors, wherein each testing thread is fixedly run on one of the processors; B. distributing a physical memory according to a processor node so that each testing thread is distributed to access a remote physical memory that is not a physical memory of the processor node on which the testing thread is currently running; C. performing, by a driver, a memory mapping of mapping the remote physical memory to a linear space of the testing thread; and D. performing, by the testing thread, read-write access to the remote physical memory in a user mode.

### TECHNICAL FIELD

The present invention relates to the field of CPU performance test, and particularly relates to a pressure testing method and a pressure testing device for a quick path interconnect bus.

### BACKGROUND

The quick path interconnect (QPI) bus technology is a developing bus technology for a multi-core CPU to access system memories, and the bus technology can improve the multi-core CPU's speed and capability of accessing the system memories by directly interconnecting CPU chips. A QPI data packet includes 80 bits, and the whole data packet is transmitted by two clock cycles or four times (the clock signal rate of QPI is half of the transmission rate). Among 20-bitdata of each transmission, 16-bit data are substantially effective, and the remaining 4bit data are used for a cyclic redundancy check to improve the reliability of a system. Because the QPI data transmission is bidirectional, i.e., data transmitted from one end can also be received during data transmission from the other end, in this way, as to a bus the QPI frequency (transmission times in each second) of which is 4.8 GT/s of a total bandwidth, the total bandwidth of each QPI bus is theoretically 19.2 GB/s and the QPI frequency is 6.4 GT/s of the total bandwidth, namely 6.4 GT/s×2 Byte×2=25.6 GB/s. This is only the theoretical data transmission rate of the QPI bus. The actually tested data transmission rate of the QPI bus utilized by the multi-core CPU is often far lower than the theoretical bandwidth index.

A general bus rate testing method is to randomly perform continuous read-write tests on continuous linear memory areas in a user mode so as to apply pressure to a multi-core CPU and obtain a testing result of the bus data transmission rate. In physical memory spaces that can be accessed by the multi-core CPU, memories include a local physical memory of a node where the CPU is located, remote physical memories of local physical memories which is accessed by QPI buses and belong to other CPU nodes, and other physical memories connected to system buses. When the memories of the multi-core CPU are being accessed, the general testing method cannot guarantee that the memory area for testing access is distributed to the local physical memories, the remote physical memories or other memories in the abovementioned memory areas. Therefore, the method for testing the performance of the CPU and the QPI bus is extremely inaccurate. On the one hand, uneven pressure applied to each core in the multi-core CPU brings about waste for the overall performance of the multi-core CPU. On the other hand, a low hit rate of the QPI bus that prompts massive data transmission access to be performed via local memories cannot effectively test the pressure bearing capability of the QPI bus.

### SUMMARY

In view of the abovementioned problem that the pressure bearing capability of the QPI bus cannot be accurately and effectively tested, the present invention provides a pressure testing method for a quick path interconnect bus, including the following steps:

A. running a plurality of testing threads on a plurality of processors, wherein each testing thread is fixedly run on one of the processors;

B. distributing a physical memory according to a processor node so that each testing thread is distributed to access a remote physical memory that is not a memory of the processor node on which the testing thread is currently running;

C. performing, by a drive, a memory mapping of mapping the remote physical memory to a linear space of the testing thread; and

D. performing, by the testing thread, read-write access to the remote memory in a user mode.

The present invention further provides a pressure testing device for a quick path interconnect bus, comprising:

a testing thread distribution device, configured to run a plurality of testing threads on a plurality of processors, wherein each testing thread is fixedly run on one of the processors;

a physical memory distribution device, configured to distribute a physical memory according to a processor node so that each testing thread is distributed to access a remote physical memory that is not a memory of the processor node on which the testing thread is currently running;

a physical memory mapping device, configured to perform, by a drive, a memory mapping of mapping the remote physical memory to a linear space of the testing thread; and

a testing device, configured to perform read-write access to the remote physical memory by the testing thread in a user mode.

The abovementioned technical solution can effectively apply pressure to the quick path interconnect bus, enable the data transmission rate of the quick path interconnect bus to approach a theoretical value thereof and can more accurately test the performance of the quick path interconnect bus when compared to a common method.

The above description merely gives a brief summary of the present invention in order to provide a basic understanding on some aspects of the present invention. It should be understood that the summary is not an exhaustive summary of the present invention. The summary neither intends to determine key elements of the present invention nor intends to define the scope of the present invention. The summary merely aims to give certain concepts in a simplified form as the preface of more detailed description below.

### BRIEF DESCRIPTION OF THE DRAWINGS

The above and other purposes, features and advantages of the present invention can be understood more easily with reference to the following description of embodiments of the present invention in combination with the drawings. Components in the drawings are merely used to illustrate the principle of the present invention. In the drawings, same or similar technical features or components will be indicated by same or similar reference signs.

FIG. 1 is a schematic diagram of a system architecture of a quick path interconnect bus among a plurality of processors according to an embodiment of the present invention;

FIG. 2 is a flow diagram of a pressure testing method for a quick path interconnect bus among a plurality of processors according to an embodiment of the present invention;

FIG. 3 provides a result of testing the performance of QPI buses by adopting a general QPI pressure testing method;

FIG. 4 provides a result of testing the performance of QPI buses only when all the threads of a system running on CPU0 access the local physical memory of CPU1 according to an embodiment of the present invention;

FIG. 5 provides a result of testing the performance of QPI buses when all the threads of the system running on CPU0 access a local physical memory of CPU1 and all the threads running on CPU1 access the local physical memory of CPU0 according to an embodiment of the present invention; and

FIG. 6 provides a pressure testing device for a quick path interconnect bus according to an embodiment of the present invention.

### DETAILED DESCRIPTION OF THE EMBODIMENTS

The embodiments of the present invention will be described below with reference to the drawings. Elements and features described in one figure or one embodiment according to the present invention may be combined with those shown in one or more other figures or embodiments. In the following description, “CPU” and “processor” and “central processor” share the same meaning It should be noted that, for the purpose of clearness, expressions and descriptions of components and processing unrelated with the present invention and known by those of ordinary skill in the art are omitted in the drawings and the description.

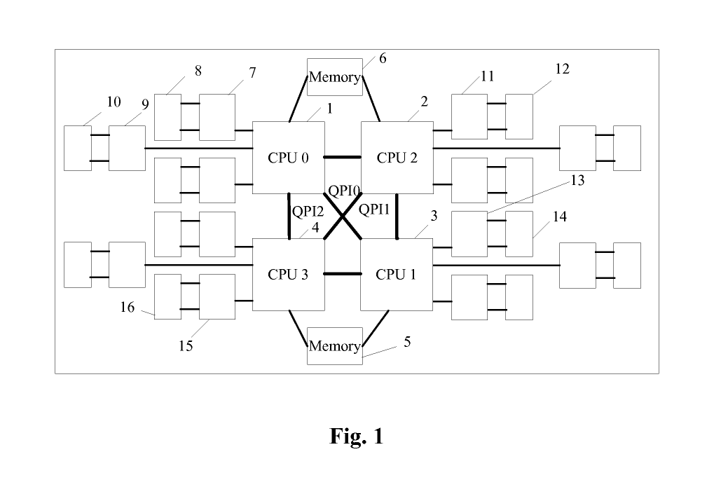

A testing system architecture of a multi-core CPU according to an embodiment of the present invention is shown in FIG. 1. The system includes four CPUs, respectively CPU0, CPU1, CPU2 and CPU3. It is certain that the system may also include more than or no more than four CPUs, and each CPU includes a plurality of cores. In addition, each CPU and a local physical memory, which is closest to the CPU and can be directly accessed via a memory controller, constitute a node, and the CPU accesses a remote physical memory serving as a local physical memory of other CPUs via a quick path interconnect (QPI) bus. For example, the CPU0 is respectively connected with local physical memories 8 and 10 via memory controllers 7 and 9, the CPU1 is connected with local physical memory 14 via memory controller 13, the CPU2 is connected with local physical memory 12 via memory controller 11, and the CPU3 is connected with local physical memory 16 via memory controller 15. The CPU0 accesses remote physical memory 14 serving as the local physical memory of the CPU1 via QPI0. The CPU2 accesses the remote physical memory 16 serving as the local physical memory of the CPU3 via QPI1. Generally, during the QPI pressure test, a testing thread is started on all the cores of each CPU respectively, and a corresponding physical memory area for read-write is distributed to each testing thread. According to this method, a memory address space for read-write test is mapped onto a continuous linear address space in a user mode. As a result of mapping, part of the address spaces are mapped to the local physical memories of the CPUs, and another part of the address spaces are mapped to the remote physical memories which are far from the specified CPUs and which need to be accessed via QPI buses; possibly another part of the address spaces are mapped to an external DRAM which cannot be directly accessed by each CPU. Because speeds of the CPUs are far higher than the access speeds supported by the memories and the pressure applied to each CPU is uneven, the overall performance of the multi-core CPU is wasted. On the other hand, because the hit rate of accessing the memories using the QPI buses is low and massive memory accesses are performed via the local physical memories, the pressure bearing capability of the QPI buses cannot be effectively tested.

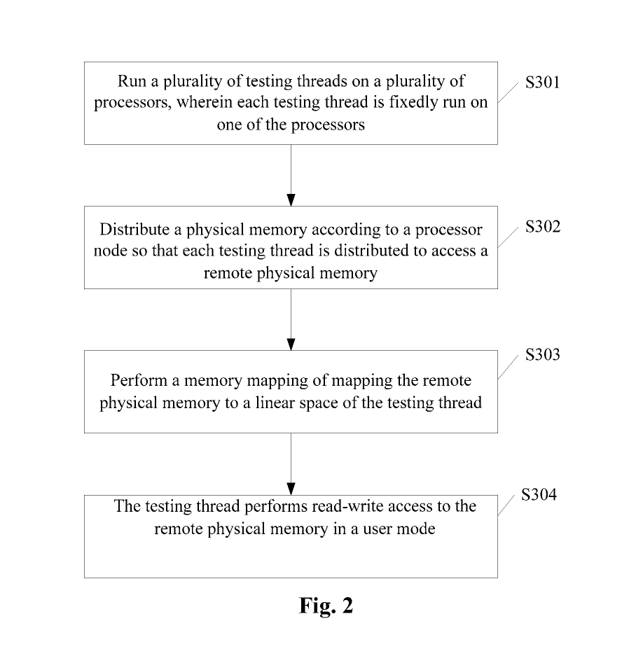

According to an embodiment of the present invention, as shown in FIG. 2, the following QPI pressure testing method is designed to improve the hit rate of each QPI bus.

S301. A plurality of testing threads run on a plurality of processors, and each testing thread is fixedly run on one core of a CPU; S302. a corresponding physical memory area is distributed to each testing thread according to processor nodes, and when the corresponding tested physical memory is distributed, physical memory distribution is performed on the tested memory according to physical spaces; S303. specifically, the current memory usage condition of each CPU is checked in a core space to discover physical memory areas which may be distributed, and a remote physical memory area to be occupied is locked in a memory management framework of a tested core; then a memory mapping is performed, and the locked remote memory areas are reversely mapped to linear spaces of the testing threads; and S304. read-write test is performed in the corresponding memory spaces in a user mode. In this way, it can thoroughly ensure that each core necessarily accesses a remote physical memory which can actually apply pressure to a QPI, and it can also ensure that all the accesses to the memories hit the QPI buses.

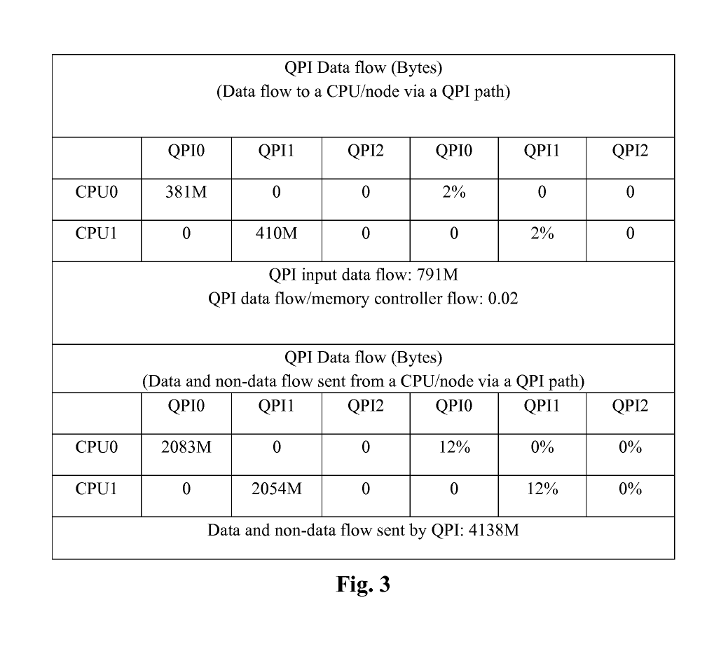

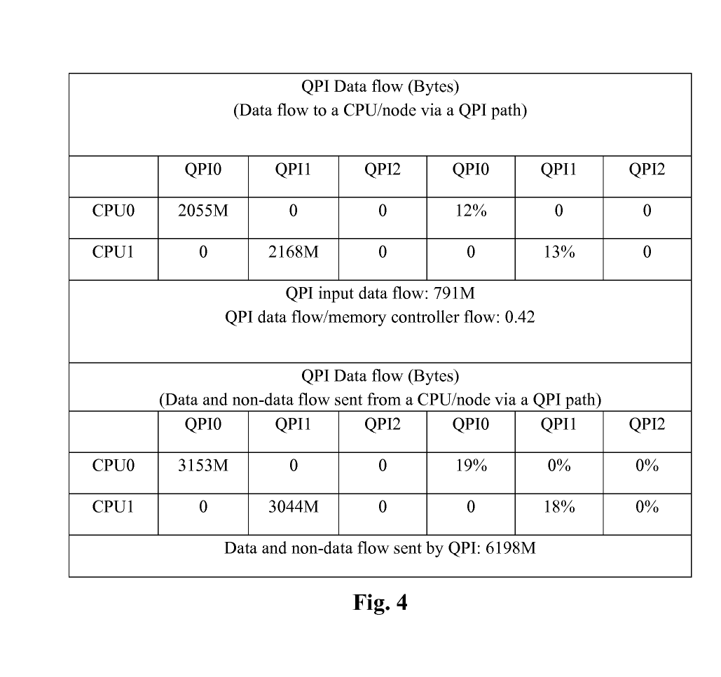

To better show the beneficial technical effects obtained by adopting the QPI pressure testing method of the present invention with respect to the QPI pressure testing method of the prior art, FIG. 3 and FIG. 4 respectively provide testing results of two QPI pressure testing methods.

FIG. 3 provides a result of performing read-write operation on a group of memories by adopting a general QPI pressure testing method (random memory mapping) to test the performance of QPI buses in FIG. 1. It is shown from FIG. 3 that, the data flow entering and exiting the CPUs via QPIs within a specified time are respectively 791 MB and 4138 MB, which only account for 2% and 12% of the theoretical total bandwidths of the QPI respectively. Thus, the QPI pressure effect under huge physical memory access pressure is far lower than the memory access pressure. That is to say, many read-writes on memories cannot be accurately positioned to remote memories, generating such a phenomenon.

FIG. 4 provides a result of performing a read-write operation on a group of memories with a same volume by adopting the QPI pressure testing method of the present invention to test the performance of QPI buses in FIG. 1. To explicitly demonstrate the capability that the pressure testing method of the present invention can accurately access remote physical memories, it is necessary to only let the testing threads bounding to all the cores of the CPU0 access the local physical memory of the CPU1.

It is shown in FIG. 4 that, the pressure of accessing the memories of the system via the QPI buses is greatly enhanced, and the data flows entering and exiting the CPUs via the QPI buses are respectively 4223 MB and 6197 MB, which are respectively increased to about 12% and 18% of the theoretical total bandwidths of the QPI. Thus, the pressure testing method according to the present invention effectively enhances the hit rate of the QPI buses and improves the accuracy of the actual performance test of the QPI buses.

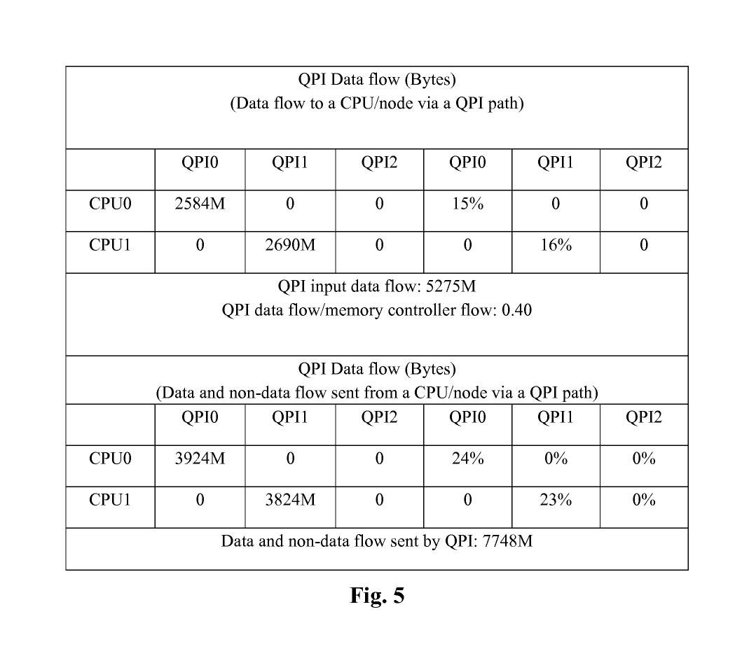

FIG. 5 provides a result of testing the performance of QPI buses by adopting the QPI pressure testing method of the present invention to perform read-write operation on a group of memories with the same volume and therefore all the threads of the system in FIG. 1 running on the CPU0 access the local physical memory of the CPU1. Meanwhile, all the threads running on the CPU1 access the local physical memory of the CPU0. Because the remote physical memories are accessed by both CPU0 and CPU1, the directivity of physical memory access cannot be embodied under such condition.

It is shown in FIG. 5 that, under the condition that both of two CPUs (CPU0 and CPU1) access remote memories, the hit rate of the QPI buses is further improved, and the data flows entering and exiting the CPUs via the QPI buses are respectively 5275 MB and 7748 MB, which are respectively improved to about 16% and 24% of the theoretical total bandwidths of the QPI.

By adopting the QPI pressure testing method of the present invention and by utilizing a dedicated test tool, PCM, from Intel to carry out a QPI bus performance test of a read-write operation of another group of memories on the above multi-core system platform including four CPUs, results are as follows: the highest data access of entering the CPU0 via the QPI0 can reach 60% of the theoretical total bandwidths of the QPI and the data access of leaving the CPU0 via the QPI0 can reach 92% of the theoretical total bandwidths of the QPI, substantially approaching actual performance limits thereof. The results obtained by adopting the general QPI pressure testing method (the random physical memory mapping) to perform read-write operation test of a group of memories in the same volume are as follows: the highest data access of entering the CPU0 via the QPI0 can reach 2% of the theoretical total bandwidths of the QPI, and the data access of leaving the CPU0 via the QPI0 can reach 12% of the theoretical total bandwidths of the QPI.

Therefore, the abovementioned QPI pressure testing method can effectively apply pressure to a quick path interconnect bus and enables the data transmission rate of the quick path interconnect bus to approach the theoretical value thereof, more accurately testing the performance of the quick path interconnect bus compared to the general method.

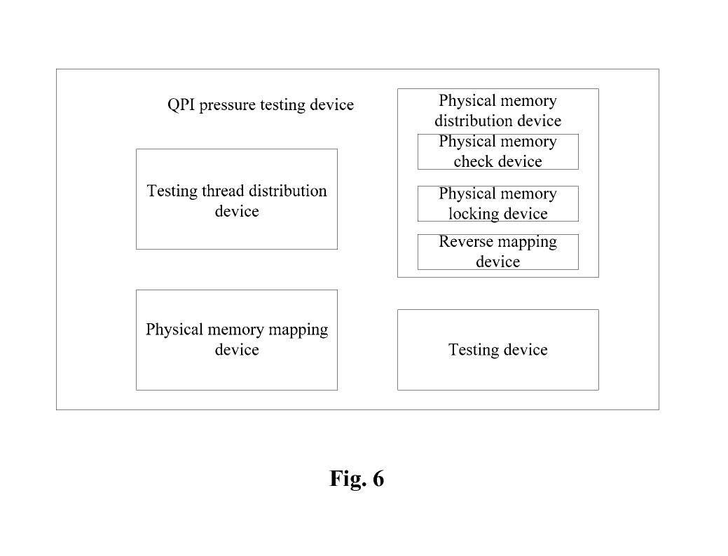

The present invention further provides a pressure testing device for a quick path interconnect bus, and the block diagram of the device is shown in FIG. 6, including: a testing thread distribution device, configured to run a plurality of testing threads on a plurality of processors, wherein each testing thread is fixedly run on one of the processors; a physical memory distribution device, configured to distribute a physical memory according to a processor node so that each testing thread is distributed to access a remote physical memory that is not a memory of the processor node on which the testing thread is currently running; a physical memory mapping device, configured to perform, by a drive, a memory mapping of mapping the remote physical memory to a linear space of the testing thread; and a testing device, configured to perform, by the testing thread, read-write access to the remote memory in a user mode.

The physical memory distribution device further includes: a physical memory check device, configured to identify the available remote physical memory for each processor by entering into a kernel space and checking a current usage condition of the physical memory, if the physical memory is distributed; a physical memory locking device, configured to lock the available remote physical memory to be occupied by each processor in a memory management framework; and a reverse mapping device, configured to reversely map the available remote physical memory after locking to a user space. It is further discovered through the abovementioned QPI pressure test that, for a multi-core CPU system, a plurality of testing threads can be run on each core, but an optimal pressure testing result is obtained only when one testing thread is run on each core. If a plurality of testing threads are run on a core, pressure may not be applied to the maximum due to resource conflicts and the like.

The above pressure testing device can effectively apply pressure to a quick path interconnect bus and enables the data transmission rate of the quick path interconnect bus to approach the theoretical value thereof, more accurately testing the performance of the quick path interconnect bus compared to the general method.

Finally, it should be noted that, the above embodiments are merely used for interpreting the technical solution of the present invention, rather than limiting the present invention. Although the present invention is described in detail with reference to the aforementioned embodiments, those of ordinary skill should understand that, the technical solution of each aforementioned embodiment can still be modified, or part of technical features therein can be equivalently substituted; and these modifications or substitutions enable the essence of the corresponding technical solution not to depart from the spirit and scope of the technical solution of each embodiment of the present invention.

1. A pressure testing method for a quick path interconnect bus, comprising the following steps:
A. running a plurality of testing threads on a plurality of processors, wherein each testing thread is fixedly run on one of the processors;
B. distributing a physical memory according to a processor node so that each testing thread is distributed to access a remote physical memory that is not a memory of the processor node on which the testing thread is currently running;
C. performing a memory mapping of mapping the remote physical memory to a linear space of the testing thread; and
D. performing, by the testing thread, read-write access to the remote physical memory in a user mode.

2. The method of claim 1, wherein step B further comprises the following steps:
E. identifying the available remote physical memory for each processor by entering into a kernel space and checking a current usage condition of the physical memory, if the physical memory is distributed;
F. locking the available remote physical memory to be occupied by each processor in a memory management framework; and
G. reversely mapping the available remote physical memory after locking to a user space.

3. The method of claim 1, wherein only one testing thread is fixedly run on one of the plurality of processors.

4. A pressure testing device for a quick path interconnect bus, comprising:
a testing thread distribution device, configured to run a plurality of testing threads on a plurality of processors, wherein each testing thread is fixedly run on one of the processors;
a physical memory distribution device, configured to distribute a physical memory according to a processor node so that each testing thread is distributed to access a remote physical memory that is not a memory of the processor node on which the testing thread is currently running;
a physical memory mapping device, configured to perform a memory mapping of mapping the remote physical memory to a linear space of the testing thread; and
a testing device, configured to perform read-write access to the remote physical memory by the testing thread in a user mode.

5. The pressure testing device of claim 4, wherein the physical memory distribution device further comprises:
a physical memory check device, configured to identify the available remote physical memory for each processor by entering into a kernel space and checking a current usage condition of the physical memory, if the physical memory is distributed;
a physical memory locking device, configured to lock the available remote physical memory to be occupied by each processor in a memory management framework; and
a reverse mapping device, configured to reversely map the available remote physical memory after locking to a user space.
